(19) United States
(12) Patent Application Publication
(10) Pub. No.: US 2009/0303481 A1
(43) Pub. Date: Dec. 10, 2009

(54) OPTICAL COMPONENT, A FRONT/BACK IDENTIFYING METHOD FOR THE OPTICAL COMPONENT, AND A FRONT/BACK IDENTIFYING DEVICE FOR THE OPTICAL COMPONENT

(76) Inventor: Nobuhiko Nakai, Tsu-shi (JP)

Correspondence Address: NIXON & VANDERHYE, PC, 901 NORTH GLEBE ROAD, 11TH FLOOR, ARLINGTON, VA, 22203, US

(21) Appl. No.: 12/158,415

(22) PCT Filed: Oct. 20, 2006
(86) PCT No.: PCT/JP2006/320946

§ 371 Date: Jul. 29, 2009

(30) Foreign Application Priority Data
Dec. 20, 2005 (JP) 2005-366005

(51) Int. Cl. G01N 21/21; G02B 27/28

(52) U.S. Cl. 356/370; 359/485

(57) ABSTRACT

An optical component including a protective film laminated on its front side and a separator on its back side, of which the front or back is easily identified, a front/back identifying method for the component, which is simple, and neither hinders other inspections nor destroys/scratches the component, and a front/back identifying device for the component.

Using the device including an analyzer 6 for an optical component 1 configured such that when a crossed Nicols arrangement is formed between the component 1 and the analyzer 6, an amount or a hue of light transmitting through the arrangement when placed in the arrangement is a protective film 3 differs from that when placed therein is a separator 5, the front or back of the component 1 is identified by observing the light to identify which film is placed in the arrangement based on the amount or the hue of the light.

### BACKGROUND OF THE INVENTION

1. Field of the Invention

The present invention relates to an optical component which includes a polarizing base material having a polarizing plate and other members, a protective film laminated on a front surface of the polarizing base material and a separator laminated on a back surface thereof, and is bonded to a liquid crystal cell at the time of assembling a liquid crystal panel, a front/back identifying method for identifying the front or back of the optical component, and a front/back identifying device used for identifying the front or back of the optical component.

2. Description of the Related Art

A liquid crystal panel which is generally used for a liquid crystal display device includes a liquid crystal cell in which liquid crystal is sealed in between a pair of glass substrates on which transparent electrodes and other members are provided, and an optical component having a polarizing base material, a phase difference plate and other members and laminated on the liquid crystal cell. The liquid crystal panel is manufactured by bonding the optical component to the liquid crystal cell via an adhesive layer.

Conventionally, in order to facilitate bonding the optical component to the liquid crystal cell, the optical component is provided with the adhesive layer in advance on a back surface of the optical component and a separator laminated on the adhesive layer. Bonding the optical component with the adhesive layer to the liquid crystal cell is performed simply by peeling off the separator from the optical component so as to expose the adhesive layer and bonding the optical component to the liquid crystal cell. Meanwhile, on a front surface of the optical component, which is opposite to the side provided with the adhesive layer, a protective film for protecting a surface of the polarizing plate is laminated.

The protective film on the optical component is provided in order to protect the surface of the optical component by preventing damage or soil thereon during the entire process of carriage and bonding of the optical component, and assembly of the liquid crystal display device after bonding the optical component. Accordingly, the protective film on the optical component is kept bonded to the surface of the optical component without being peeled off until the end of manufacturing processes of the liquid crystal display device.

A mistake about the front or back of the optical component when bonding the optical component to the liquid crystal cell causes the protective film on the front surface of the optical component to be mistakenly peeled off, not the separator on the back surface thereof to be peeled off. If the protective film is once peeled off from the optical component, the peeled-off protective film cannot be neatly bonded to the optical component again due to air bubbles or dust at a bonding interface. In addition, if a gap is formed between the protective film and the polarizing plate due to air bubbles or other objects, there is a possibility of generating air bubbles between the polarizing plate and the liquid crystal cell to be bonded, or a possibility of defective crimping due to insufficient leveling of a panel in a mounting process of drivers.

As described above, if the protective film on the optical component is mistakenly peeled off, the optical component becomes a defective and cannot be used anymore. Accordingly, it is extremely an important issue that the separator on the optical component is reliably peeled off without a mistake about the front or back of the optical component.

As a conventional front/back identifying method for the optical component, used is a method such that the side face of the optical component is visually observed so as to check a layer configuration, the polarizing plate and the phase difference plate are identified based on a difference in reflectance, and the separator on the optical component is identified based on a positional relationship between the polarizing plate and the phase difference plate.

In addition, as the front/back identifying method for the optical component, known is a method such that a mark for identification is directly provided on the optical component in advance, and the front or back of the optical component is identified by visually observing the mark for identification (see Japanese Patent Application Unexamined Publication No. 2000-321422).

Further, as the front/back identifying method for the optical component, used are a method such that colors of the protective film and the separator are differentiated and the front or back of the optical component is identified based on the difference of the colors, and a method such that when manufacturing the optical components and packing them in boxes, the separator side surfaces of the optical components are placed face down, and when unpacking the boxes, the lower side surfaces are identified as the separator side surfaces.

However, the conventional method for identifying the front or back of the optical component by visually observing the surface of the optical component in order to identify the phase difference plate has a problem that not everyone can identify the front or back of the optical component reliably because there are great differences among individuals, for example, a worker having weak eyes cannot identify the phase difference plate.

In addition, conventionally, the optical component is configured such that the phase difference plate such as a phase difference film is laminated on the polarizing plate. However, in recent years, a phase difference layer is formed by coating a resin constituting the phase difference layer on the polarizing plate. In this case, the phase difference layer is made extremely thinner than the conventional phase difference plate. Further, in recent years, some polarizing plates themselves have a phase difference function. As a result, it becomes impossible to identify the phase difference layer based on a cross-sectional configuration and the thickness by visually observing the side face of the optical component.

The method described in the Japanese Patent Application Unexamined Publication No. 2000-321422 has a problem that it takes a lot of time and work to provide the marks for identification on all of the optical components. In addition, when the optical component becomes larger in accordance with upsizing of the liquid crystal display device, it takes a lot of time and work to detect the position of the mark for identification and to read the mark. Further, the method has a problem that if ink of the mark is put on the optical component, the ink is reprinted on other members and soils them.

The method such that the protective film and the separator are colored in different colors and the front or back of the optical component is identified based on the difference of the colors, has a possibility that when performing an inspection of the optical component and the liquid crystal panel, the colors may hinder the inspection.

In addition, the method such that either the front surfaces or the back surfaces of the optical components are always placed face up or placed face down in the box when packing the optical components, has a possibility that even if the separator side surfaces of the optical components are always placed face up when packing the optical components, if the optical component is taken out of the box once, is set in a bonding device and is returned to the box, the optical component may be mistakenly packed upside down. In this case, it is impossible to identify the front or back of the optical component unless the protective film or the separator is peeled off. However, if the front or back of the optical component can be identified just before the optical component is bonded to the liquid crystal cell even in a case where the optical component is mistakenly packed upside down, a problem caused by bonding the optical component to the liquid crystal cell while making a mistake about the front or back of the optical component can be prevented.

### SUMMARY OF THE INVENTION

In order to overcome the problems described above, preferred embodiments of the present invention provide an optical component which comprises a polarizing base material having a polarizing plate, a protective film laminated on a front surface of the polarizing base material and a separator laminated on a back surface of the polarizing base material, of which the front or back can be easily identified, a front/back identifying method for the optical component, which is simple and by which inspections are not hindered and the separator side surface of the optical component and the protective film side surface thereof can be reliably identified without destroying or scratching the optical component, and a front/back identifying device for the optical component.

In order to overcome the problems described above, an optical component according to preferred embodiments of the present invention comprises a polarizing base material having a polarizing plate, a protective film laminated on a front surface of the polarizing base material, and a separator laminated on a back surface of the polarizing base material, wherein when a crossed Nicols arrangement is formed between the optical component and an independently-prepared analyzer, an amount or a hue of light transmitting through the crossed Nicols arrangement in a case where placed in the crossed Nicols arrangement is the protective film differs from the amount or the hue of the light transmitting through the crossed Nicols arrangement in a case where placed in the crossed Nicols arrangement is the separator.

In the optical component according to the preferred embodiments of the present invention, the protective film and the separator have different orientation angles.

In the optical component according to the preferred embodiments of the present invention, the protective film and the separator have different retardation values.

In the optical component according to the preferred embodiments of the present invention, the amount of the light transmitting through the crossed Nicols arrangement is arranged to be minimum when one of the protective film and the separator is placed in the crossed Nicols arrangement.

In the optical component according to the preferred embodiments of the present invention, the amount of the light transmitting through the crossed Nicols arrangement is arranged to be minimum when the separator is placed in the crossed Nicols arrangement.

In the optical component according to the preferred embodiments of the present invention, the protective film and the separator are uncolored and transparent.

In the optical component according to the preferred embodiments of the present invention, the separator is laminated on the polarizing base material via an adhesive layer.

In the optical component according to the preferred embodiments of the present invention, the polarizing base material is formed by coating a phase difference layer on the polarizing plate or the polarizing base material itself has a phase difference function.

An front/back identifying method of identifying the front or back of an optical component which comprises a polarizing base material having a polarizing plate, a protective film laminated on a front surface of the polarizing base material and a separator laminated on a back surface of the polarizing base material, the method comprising the steps of placing the optical component and an independently-prepared analyzer so as to form a crossed Nicols arrangement, the optical component being arranged so that an amount or a hue of light transmitting through the crossed Nicols arrangement in a case where placed in the crossed Nicols arrangement is the protective film differs from the amount or the hue of the light transmitting through the crossed Nicols arrangement in a case where placed in the crossed Nicols arrangement is the separator, and observing the light transmitting through the crossed Nicols arrangement so as to identify the front or back of the optical component based on the amount or the hue of the light transmitting through the crossed Nicols arrangement.

In the front/back identifying method for the optical component according to the preferred embodiments of the present invention, the light transmitting through the crossed Nicols arrangement is observed respectively in a case where one of planes of the optical component is placed in the crossed Nicols arrangement and in a case where the other plane of the optical component is placed in the crossed Nicols arrangement and the front or back of the optical component is identified based on the difference of the amount or the hue of the light transmitting through the crossed Nicols arrangement between the above cases.

In the front/back identifying method for the optical component according to the preferred embodiments of the present invention, the optical component is inverted, the light transmitting through the crossed Nicols arrangement before and after inverting the optical component is observed, and the front or back of the optical component is identified based on the difference of the amount or the hue of the light transmitting through the crossed Nicols arrangement.

A front/back identifying device for an optical component which comprises a polarizing base material, a protective film laminated on a front surface of the polarizing base material and a separator laminated on a back surface of the polarizing base material comprises an analyzer which forms a crossed Nicols arrangement in combination with the optical component.

The front/back identifying device according to the preferred embodiments of the present invention further comprises a light source for irradiate light to be transmitted through the crossed Nicols arrangement.

The front/back identifying device according to the preferred embodiments of the present invention further comprises a transmitting light observation mechanism to observe an amount or a hue of the light transmitting through the crossed Nicols arrangement.

The front/back identifying device according to the preferred embodiments of the present invention further comprises an identifying mechanism arranged to identify the front or back of the optical component based on an observation result by the transmitting light observation mechanism and a carrier control mechanism arranged to control a carrier of the optical component to be carried based on an identification result by the identifying mechanism.

In the front/back identifying device according to the preferred embodiments of the present invention, the analyzer is a polarizer-equipped camera.

In the front/back identifying device according to the preferred embodiments of the present invention, the analyzer is polarizer-equipped spectacles.

In the optical component according to the preferred embodiments of the present invention, the optical component is laid on the analyzer so that a polarizing axis of the polarizing plate of the optical component and a polarizing axis of a polarizing plate of the analyzer intersect at right angles so as to form the crossed Nicols arrangement. When observing the light transmitting through the crossed Nicols arrangement, obtained is an observation result such that the amount or the hue of the light transmitting through the crossed Nicols arrangement in a case where the separator is placed in the crossed Nicols arrangement differs from that in a case where the protective film is placed in the crossed Nicols arrangement. Accordingly, if the amount or the hue of the light transmitting through the crossed Nicols arrangement respectively in a case where the protective film is placed in the crossed Nicols arrangement or in a case where the separator is placed in the crossed Nicols arrangement is previously determined, the front or back of the optical component can be identified based on the determination.

In the optical component according to the preferred embodiments of the present invention, it is not necessary to provide a mark for identification or other on the protective film, the separator or other members, whereby a process of providing the mark for identification is not necessary, which facilitates manufacture. In addition, there is no possibility that ink of the mark for identification may be reprinted on other members and soil them.

In the optical component according to the preferred embodiments of the present invention, it is not necessary to provide a mark for identification outside a display region of the liquid crystal display device and the optical component can be uniformly made over the whole plane, whereby the whole optical component can be used as a display region of a liquid crystal panel.

In the optical component according to the preferred embodiments of the present invention, the identification of the front or back of the optical component can be made in the whole plane of the optical component. Accordingly, when the crossed Nicols arrangement is formed between the optical component and the analyzer, the whole plane of the optical component can be used and time and work for detecting the position of the mark for identification can be saved, which leads to excellent operability in identifying the front or back of the optical component.

In the optical component according to the preferred embodiments of the present invention, when a plurality of the optical components in a box are taken out of the box and are set in a bonding device so as to perform bonding, and the optical components are returned to the box when bonding the optical component to a liquid crystal cell in a manufacturing process of the liquid crystal panel, even if the optical component is returned to the box while making a mistake about the front or back of the optical component, the front or back of the optical component can be easily identified by using a simple method of only observing the light transmitting through the crossed Nicols arrangement formed by combining the optical component and the analyzer when the optical component is set in the bonding device or other devices again or just before the optical component is bonded to the liquid crystal cell.

In the front/back identifying method for the optical component according to the preferred embodiments of the present invention, the above-described optical component and the analyzer are placed so as to form the crossed Nicols arrangement, the light transmitting through the crossed Nicols arrangement is observed and the front or back of the optical component is identified based on the amount or the hue of the light transmitting through the crossed Nicols arrangement. Accordingly, the front or back of the optical component can be identified by the simple method of only observing the light transmitting through the crossed Nicols arrangement formed by the optical component and the analyzer, which does not hinder other inspections and does not destroy or scratch the optical component.

In the front/back identifying method for the optical component according to the preferred embodiments of the present invention, the front or back of the optical component can be easily and reliably identified. Accordingly, the optical component can be prevented from being a defective caused by mistakenly peeling off the protective film though the separator is to be peeled off because a mistake about the front or back of the optical component is made.

The front/back identifying device for the optical component according to the preferred embodiments of the present invention includes the analyzer which forms the crossed Nicols arrangement in combination with the optical component. It is sufficient that the analyzer consists of a polarizing plate, and it is possible to reliably identify the separator side surface or the protective film side surface of the optical component.

### BRIEF DESCRIPTION OF THE DRAWINGS

FIG. 1 is a sectional view showing one example of an optical component according to a preferred embodiment of the present invention.

FIG. 2 is a view illustrating a front/back identifying method for the optical component.

FIG. 3 is a view showing an in-plane phase difference of a protective film of the optical component shown in FIG. 1.

FIG. 4 is a view showing an in-plane phase difference of a separator of the optical component shown in FIG. 1.

FIG. 5 is a view illustrating one example of a front/back identifying device for the optical component according to the preferred embodiment of the present invention.

FIG. 6 is a view illustrating another example of the front/back identifying device for the optical component according to the preferred embodiment of the present invention.

### DETAILED DESCRIPTION OF PREFERRED EMBODIMENTS

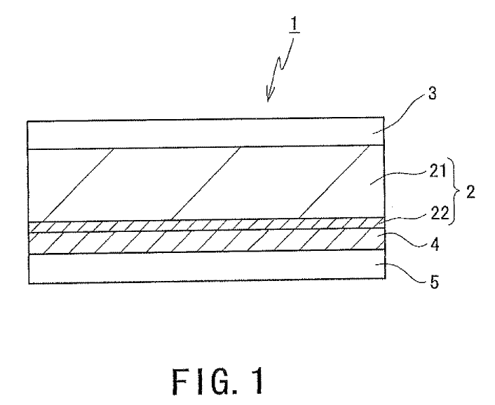

A detailed description of preferred embodiments of the present invention will now be provided with reference to the accompanying drawings. FIG. 1 is a sectional view showing one example of an optical component according to a preferred embodiment of the present invention. An optical component 1 shown in FIG. 1 includes a polarizing base material 2 provided with a polarizing plate 21, and a phase difference layer 22 on a back surface of the polarizing plate 21. A protective film 3 is laminated on a front surface of the polarizing base material 2, an adhesive layer 4 is provided on the phase difference layer 22 on a back side of the polarizing base material 2, and a separator 5 is laminated on the adhesive layer 4 on the back side of the polarizing base material 2.

It is essential only that the polarizing base material 2 of the optical component 1 according to the preferred embodiment of the present invention includes at least the polarizing plate 21. The polarizing base material 2 can include the phase difference layer 22 laminated on the polarizing plate 21 as shown in FIG. 1. As the phase difference layer 22, an independently-prepared phase difference plate may be laminated on the polarizing plate 21, but it is preferable that the phase difference layer 22 is formed on the polarizing plate 21 by coating a constituent of the phase difference layer 22 on the polarizing plate 21. For example, while it is necessary for the independently-prepared phase difference plate to have the thickness of about 100 μm, it is sufficient for the phase difference layer formed by coating to have the thickness of about 5 μm. The polarizing base material 2 itself may have a function as a phase difference layer (a phase difference function) to be described later.

For the polarizing plate 21 used in the polarizing base material 2, an appropriate one can be used if it is a polarizer used in manufacturing a liquid crystal display device. Examples of the polarizer include a variety of polarizing films formed by having a hydrophilic macromolecular film such as a polyvinyl-alcohol-based film, a partial formal-polyvinyl-alcohol-based film and an ethylene-vinyl-acetate-copolymer-based saponificated film to absorb iodine or a two-tone dye and to be uniaxially-stretched, and a polyene-oriented film such as a dehydrated product of polyvinyl alcohol and a dichlorinated product of polyvinyl chloride.

The polarizing plate 21 may be configured such that a transparent protection layer formed by laminating a transparent film, coating a transparent resin or other ways is laminated on one side or both sides of the polarizing film.

As the phase difference layer 22 used in the polarizing base material 2, a ½ wavelength plate and a ¼ wavelength plate for preventing coloring based on a phase difference generated by a liquid crystal cell, a viewing angle compensator for widening a viewing angle and other plates are used. Examples of the phase difference layer 22 include a stretch transparent plastic film such as an uniaxially- or biaxially-stretched film of polyolefin such as polyethylene and polypropylene, polycarbonate, polyester, polyether sulfone, polystyrene, polyvinyl alcohol, cellulose acetate, polyvinyl chloride, polymethylmethacrylate, polyvinylidene chloride, polyarylate, polyamide, norbornene-based resin, an oriented-film such as liquid crystal polymer, and a layer such that an oriented layer such as liquid crystal polymer is provided on a transparent base material.

When a liquid crystal panel is constructed by bonding the optical component 1 to the liquid crystal cell, the protective film 3 is positioned at an outermost front surface of the liquid crystal panel and protects a front surface of the optical component 1 without being peeled off until the end of manufacturing processes of the liquid crystal display device. The protective film 3 is directly laminated on the front surface of the polarizing base material 2.

The separator 5 is used as a so-called peeling sheet for protecting the adhesive layer 4 from a dust and dirt by covering it until the separator 5 is peeled off so as to expose the adhesive layer 4 when the optical component 1 is bonded to the liquid crystal cell. When the separator 5 is peeled off from the optical component 1, the peel-off is made at an interface with the adhesive layer 4 and the adhesive layer 4 remains on the polarizing base material 2 side. Until the optical component 1 is bonded to the liquid crystal cell, the optical component 1 is stored while being rolled up or being stacked in layers with the polarizing base material 2 being provided with the protective film 3 and the adhesive layer 4. In this case, the separator 5 laminated on the adhesive layer 4 prevents the protective film 3 from being bonded to the adhesive layer 4.

It is sufficient that the protective film 3 and the separator 5 are films capable of controlling light transmitting through a crossed Nicols arrangement to be described later. The films used for the protective film 3 or the separator 5 can be appropriately selected, for example, from resin films of polyester, polycarbonate, polypropylene, polyethylene, ethylene-vinyl-acetate copolymer, polystyrene, polyamide, polyurethane, polyvinyl chloride, polyvinylidene chloride and cellulose ester. The above film can be a single layer film or a laminated film.

In order to control the light transmitting through the crossed Nicols arrangement, one or both of an orientation angle of the film to be described later and a retardation value (Δn·d) of the film to be described later are changed. In the case of changing the orientation angle of the film, a refractive index of the film in a longitudinal direction and that in a lateral direction in a plane direction of the film can be changed by changing a stretch rate of the film in the longitudinal direction and that in the lateral direction. While the retardation value (Δn·d) of the film changes depending on the type of the film, it is preferable to use a film having isotropy optically such as a cellulose acetate film manufactured by a solution casting film-forming method in order to make the retardation value smaller.

In the optical component 1 shown in FIG. 1, a polyester film having a predetermined phase difference with respect to the polarizing plate 21 is used for the protective film 3, and a triacetate film having an orientation angle which is the same as that of the polarizing plate 21 or is a multiple of π/2, showing a high degree of isotropy and having a small retardation value is used for the separator 5.

It is preferable that the optical component 1 according to the preferred embodiment of the present invention is provided with the adhesive layer 4 on the back surface of the polarizing base material 2 and the separator 5 on the adhesive layer 4. If the adhesive layer 4 is provided in advance, time and work for providing the adhesive layer 4 can be saved when bonding the polarizing base material 2 to the liquid crystal cell It is essential only that the adhesive layer 4 is capable of bonding the polarizing base material 2 to the liquid crystal cell. The adhesive layer 4 is preferably formed by an adhesive such as acrylic-based, silicone-based, polyester-based, polyurethane-based, polyether-based and rubber-based adhesives.

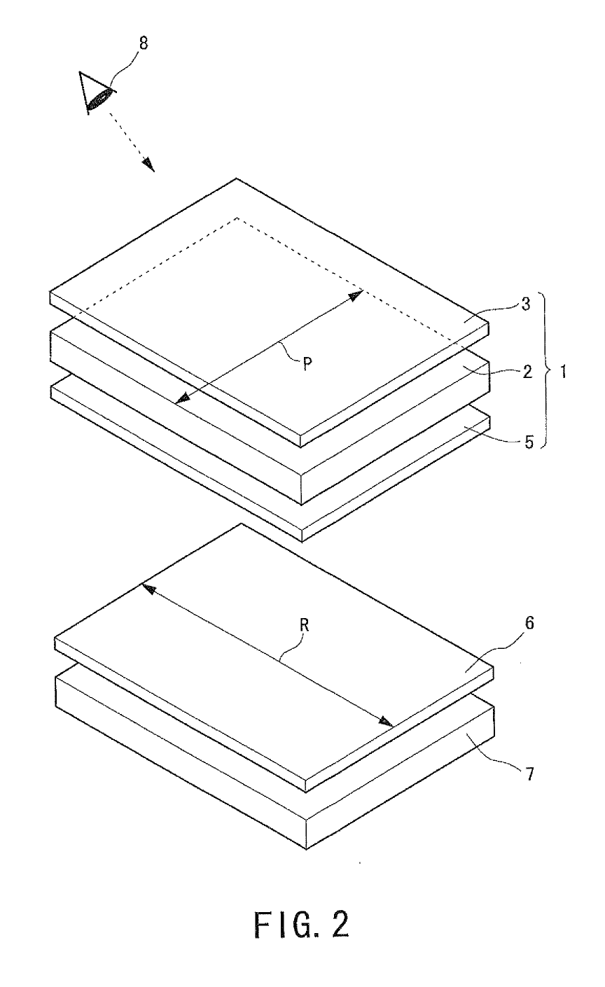

FIG. 2 is a view illustrating a front/back identifying method using the optical component 1 according to the preferred embodiment of the present invention. As shown in FIG. 2, the optical component 1 is formed so that when the crossed Nicols arrangement is formed between the optical component 1 and a independently-prepared analyzer 6, an amount or a hue of the light transmitting through the crossed Nicols arrangement in a case where the protective film 3 is placed in the crossed Nicols arrangement differs from that in a case where the separator 5 is placed in the crossed Nicols arrangement. The difference of the amount and the hue of the light transmitting through the crossed Nicols arrangement is described herein after.

In the case of identifying the front or back of the optical component 1, as shown in FIG. 2, the optical component 1 is laid on the analyzer 61 the optical component 1 and the analyzer 6 are placed so that an absorption axis P of the polarizing plate 21 of the polarizing base material 2 of the optical component 1 and an absorption axis R of a polarizer of the analyzer 6 intersect at right angles so as to form the crossed Nicols arrangement, and light from a light source 7 which transmits through the crossed Nicols arrangement is observed by an observation mechanism such as an eye 8.

It is essential only that the analyzer 6 used for the front/back identifying method according to the preferred embodiment of the present invention includes a polarizer capable of converting natural polarization into linear polarization, such as a polarizing film and a polarizing prism.

The crossed Nicols arrangement formed by laying the optical component 1 on the analyzer 6 is observed from the optical component 1 side as shown in FIG. 2. If the optical component 1 is placed so that the separator 5 of the optical component 1 is on the analyzer 6 side, the separator 5 is placed in the crossed Nicols arrangement.

In contrast, if the optical component 1 is inverted, the separator 5 is on the observer's eye 8 side with respect to the polarizing base material 2, the protective film 3 is on the analyzer 6 side, and the protective film 3 is placed in the crossed Nicols arrangement formed by the polarizing base material 2 and the analyzer 6.

The amount of the light transmitting through the crossed Nicols arrangement formed by the two polarizing plates (2, 6) of which the absorption axes intersect at right angles becomes minimum in a case where no separator and no protective film are included in the crossed Nicols arrangement, while in a case where the separator or the protective film is included therein, the light transmitting through the crossed Nicols arrangement is optically influenced and the amount or the hue of the light changes.

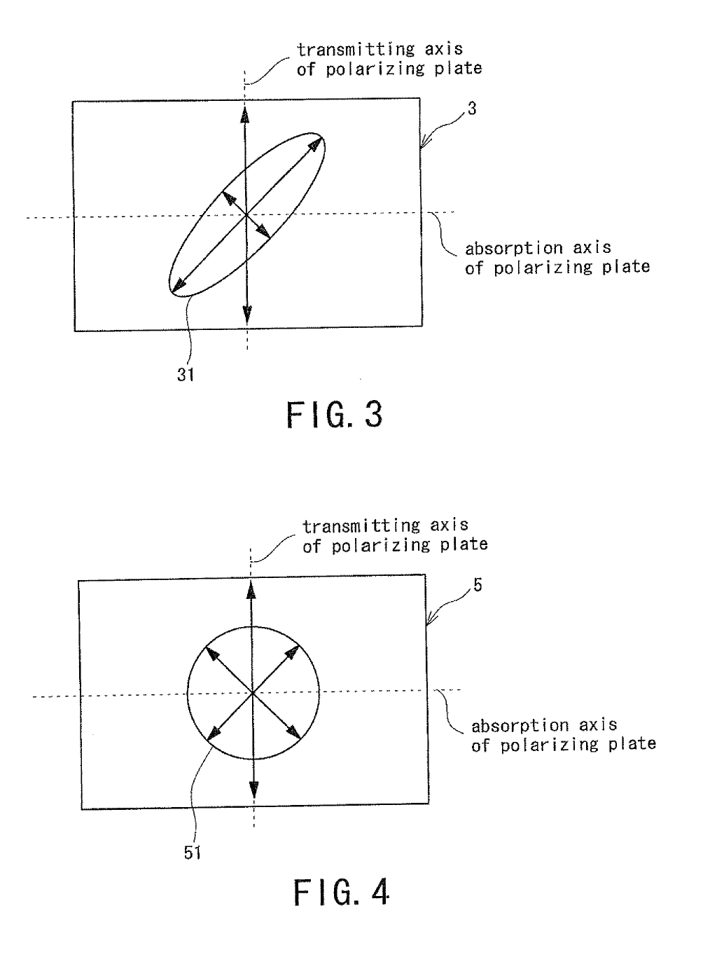

FIG. 3 is a plan view showing an in-plane phase difference of the protective film 3 of the optical component 1 in FIG. 1, and FIG. 4 is a plan view showing an in-plane phase difference of the separator 5 of the optical component 1 in FIG. 1. As shown in FIG. 3 and FIG. 4, an in-plane phase difference 31 of the protective film 3 differs from an in-plane phase difference 51 of the separator 5.

If the in-plane phase differences differ between the protective film 3 and the separator 5 as described above, the amount or the hue of the light transmitting through the crossed Nicols arrangement in a case where the separator 5 of the optical component 1 is placed in the crossed Nicols arrangement as shown in FIG. 2 differs from that in a case where the protective film 3 is placed in the crossed Nicols arrangement when the optical component 1 is inverted.

If the light transmitting through the crossed Nicols arrangement is observed by the observation mechanism such as the eye 8 as shown in FIG. 2, it is possible to determine which of the protective film 3 and the separator 5 is placed in the crossed Nicols arrangement based on the amount or the hue of the light transmitting the crossed Nicols arrangement, and thereby the front or back of the optical component 1 can be identified.

In order to configure the optical component 1 such that the amount or the hue of the light transmitting through the crossed Nicols arrangement in a case where arranged in the crossed Nicols arrangement is the protective film 3 differs from that in a case where arranged in the crossed Nicols arrangement is the separator 5, it is essential only that the protective film 3 and the separator 5 are formed such that the orientation angle or the retardation value of the protective film 3 differs from the orientation angle or the retardation value of the separator 5. The orientation angles and the retardation values of the protective film 3 and the separator 5 are described herein after.

As described above, when the analyzer 6 and the optical component 1 are placed so that the absorption axis R of the analyzer 6 and the absorption axis P of the polarizing base material 2 of the optical component 1 intersect at right angles, the amount of the light transmitting through the crossed Nicols arrangement formed by the analyzer 6 and the polarizing base material 2 becomes zero, which is the darkest, if no other films are included in the crossed Nicols arrangement. In contrast, if a transparent film having birefringence is placed in the crossed Nicols arrangement, an amount I of light transmitting through the crossed Nicols arrangement is indicated by the following expression (1)

I=A·sin²(2φ)·sin²(2πd·Δn/λ) (1)

In the expression (1), A indicates a constant, φ indicates an orientation angle of a film having birefringence, d indicates the thickness of the film, and Δn indicates refractive-index anisotropy expressed by a difference (nₑ-nₒ) between a refractive index nₑ of a long axis of the film and a refractive index nₒ of a short axis of the film. A value of the product Δn·d of Δn (the refractive-index anisotropy) and d (the thickness) is referred to as a retardation value in the preferred embodiment of the present invention. In addition, (2 πd·Δn/λ) indicates a phase difference between ordinary light and extraordinary light. When observing the light transmitting through the crossed Nicols arrangement, the light becomes darkest in a case where (2φ) is zero or (2πd·Δn/λ) is zero so that the transmitting light amount I is minimum and the crossed Nicols arrangement is in an extinction position.

In the optical component 1 according to the preferred embodiment of the present invention, in a case where the crossed Nicols arrangement is formed between the optical component 1 and the analyzer 6, if the amount of the light transmitting through the crossed Nicols arrangement becomes minimum when the protection film 3 or the separator 5 is placed in the crossed Nicols arrangement, it becomes easier to identify the protective film 3 or separator 5 since the crossed Nicols arrangement is in the extinction position when one of the films is placed in the crossed Nicols arrangement and is not in the extinction position when the other film is placed in the crossed Nicols arrangement, and thereby the front or back of the optical component 1 can be identified more reliably.

In order to arrange the crossed Nicols arrangement in the extinction position when the protective film 3 or the separator 5 is placed in the crossed Nicols arrangement, for example, (2φ) or (2πd·Δn/λ) in the expression (1) is arranged to be zero or to have a value close to zero. To be specific, (2φ) in the expression (1) depends on the orientation angle (φ) of the film, and thereby the orientation angle (φ) of one of the protective film 3 and the separator 5 is arranged to be zero and the orientation angle (φ) of the other film is arranged to have a value other than zero.

The orientation angle (φ) of the film is a difference between the absorption axis of the polarizing plate 21 of the polarizing base material 2 and a birefringent principal axis of the film. By making the absorption axis of one of the films coincide with the absorption axis of the polarizing plate 21 of the polarizing base material 2, the orientation angle (φ) can be arranged to be zero. In addition, by making the absorption axis of the other film not coincide with the absorption axis of the polarizing plate 21 of the polarizing base material 2, the orientation angle (φ) of the other film can be arranged to have the value other than zero.

It is preferable that (2πd·Δn/λ) in the expression (1) is also arranged to be zero when the orientation angle (φ) of the protective film 3 or the separator 5 is zero. To be specific, the retardation value (d·Δn) of the film is arranged to be zero. When the retardation value (d·Δn) of one of the films is arranged to be zero, the retardation value (d·Δn) of the other film is arranged to have a value other than zero.

Incidentally, in the preferred embodiment of the present invention, when it is described that the orientation angle (φ) or the retardation value (d·Δn) is zero, the description includes not only a case where the orientation angle (φ) or the retardation value (d·Δn) is exactly zero but also a case where the orientation angle (φ) or the retardation value (d·Δn) is substantially zero and the crossed Nicols arrangement is substantially in the extinction position.

While the case where the orientation angle (φ) or the retardation value (d·Δn) is arranged to be zero so that the amount I of the light transmitting through the crossed Nicols arrangement is minimum and the crossed Nicols arrangement is in the extinction position is described as an example, the transmitting light amount I becomes zero in the expression (1) when the following expressions (2) and (3) are satisfied. In other words, the amount I of the light transmitting through the crossed Nicols arrangement can be minimum if (2φ) or (2πd·Δn/λ) is arranged to be zero or an integral multiple of π in the expression (1).

sin²(2φ)=0 (2)

sin²(2πd·Δn/λ) (3)

(2πd·Δn/λ) in the expression (1) indicates the phase difference between the ordinary light and the extraordinary light of the light transmitting through a medium having birefringence, which depends on the retardation value (d·Δn) that defines the product of the refractive-index anisotropy (Δn) and the thickness (d) of the film placed in the crossed Nicols arrangement. When controlling the phase difference of the light transmitting through the crossed Nicols arrangement, it is essential only that the retardation values of the films to be placed in the crossed Nicols arrangement are differentiated. When the retardation values (d·Δn) are differentiated between the protective film 3 and the separator 5, the phases of the light transmitting through the crossed Nicols arrangement differ, which causes the difference of the hue.

When wavelength dispersion (depending on the type of the film) of the retardation values (d·Δn) differs, the extent of deviation of the phases differs in accordance with components of R, G and B in the case of using a light source such as white light, the shapes of elliptical polarization differ and white balance is broken, and thereby the hues of the light transmitting through the crossed Nicols arrangement differ. The refractive-index anisotropy (Δn) differs depending on the type and stretch rate of the film and (d) differs depending on the thickness of the film, whereby the retardation value (d·Δn) can be differentiated between the protective film 3 and the separator 5 by selecting the type and stretch rate and the thickness (d) of the films used for the protective film 3 and the separator 5.

As described above, when the orientation angles or the retardation values differ between the protective film 3 and the separator 5, the absorption axis of the polarizer which forms the crossed Nicols arrangement is influenced in the case of inverting the optical component 1 and the amount or the hue of the light transmitting through the crossed Nicols arrangement changes.

The light transmitting through the crossed Nicols arrangement in a case where one of the planes of the optical component 1 is placed in the crossed Nicols arrangement and in a case where the other plane of the optical component 1 is placed therein is observed respectively, and the front or back of the optical component 1 is identified based on the difference of the amount or the hue of the light transmitting through the crossed Nicols arrangement between the above cases. In this case, the front or back of the optical component 1 can be identified by previously determining the difference of the light transmitting through the crossed Nicols arrangement, visually observing the transmitting light emitted from the light source by the eye 8 of the observer so as to determine the difference.

When the front or back of the optical component 1 is identified based on the difference of the amount or the hue of the light transmitting through the crossed Nicols arrangement, the front or back of the optical component 1 can be identified by inverting the optical component 1, observing the transmitting light before and after inverting the optical component 1, determining which of the protective film 3 and the separator 5 is placed in the crossed Nicols arrangement based on the difference of the amount or the hue of the light transmitting through the crossed Nicols arrangement before and after inverting the optical component 1.

In the method such that the optical component 1 is inverted, the film is to be placed in the crossed Nicols arrangement can be easily changed by moving only the optical component 1 without moving the analyzer 6. This is effective when the optical component 1 is small. When the optical component 1 is large, it is effective to change the film to be placed in the crossed Nicols arrangement by moving the analyzer 6 so as to face with the other plane of the optical component 1.

When observing the light transmitting through the crossed Nicols arrangement respectively in a case where one of the planes of the optical component 1 is placed in the crossed Nicols arrangement and in a case where the other plane of the optical component 1 is placed therein, the front or back of the optical component 1 can be identified more reliably if one of the protective film 3 and the separator 5 is placed in the crossed Nicols arrangement so that the crossed Nicols arrangement is in the extinction position.

It is especially preferable that the amount of the light transmitting through the crossed Nicols arrangement is arranged to be minimum when the separator 5 is placed in the crossed Nicols arrangement as shown in FIG. 2. In this case, the amount I of the light transmitting through the crossed Nicols arrangement in the expression (1) when the optical component 1 forming the crossed Nicols arrangement is observed from the protective film 3 side becomes minimum and the crossed Nicols arrangement is made in the extinction position. With such an arrangement, detection sensitivity in an inspection of a bright spot caused by a foreign body on the phase difference layer 22 utilizing polarization can be improved.

When manufacturing the liquid crystal display device, the inspection of the bright spot caused by the foreign body is performed in a process of assembling a liquid crystal panel and the subsequent processes as an acceptance inspection of the optical component 1 which has been manufactured in separate processes in order to detect a foreign body included in or bonded to an interface between the phase difference layer 22 and the adhesive layer 4 of the optical component 1.

The inspection of the bright spot caused by the foreign body is performed by visually observing the transmitting light in a state where the phase difference layer 22 is placed in the crossed Nicols arrangement so as to arrange the crossed Nicols arrangement in the extinction position. In a normal portion of the phase difference layer 22, the transmitting light becomes minimum and the normal portion is observed as being in a dark state. If the foreign body exists in the phase difference layer 22, the portion including the foreign body changes in a polarizing axis of output light and is observed as a bright spot, whereby the foreign body can be detected. When performing the inspection, the separator 5 is placed in the crossed Nicols arrangement. In the inspection of the bright spot caused by the foreign body, if the separator 5 is placed in the crossed Nicols arrangement so that the crossed Nicols arrangement is in the extinction position, an influence on the inspection becomes minimum, which improves the detection sensitivity.

In the optical component 1 according to the preferred embodiment of the present invention, it is preferable that the protective film 3 and the separator 5 are uncolored and transparent. This eliminates a possibility of hindering various inspections in processes of assembling the liquid crystal display device, such as an inspection of a bright spot caused by a foreign body and other visual inspections. In this case, the protective film and the separator are uncolored and transparent to the extent that the above-mentioned various inspections are not substantially hindered.

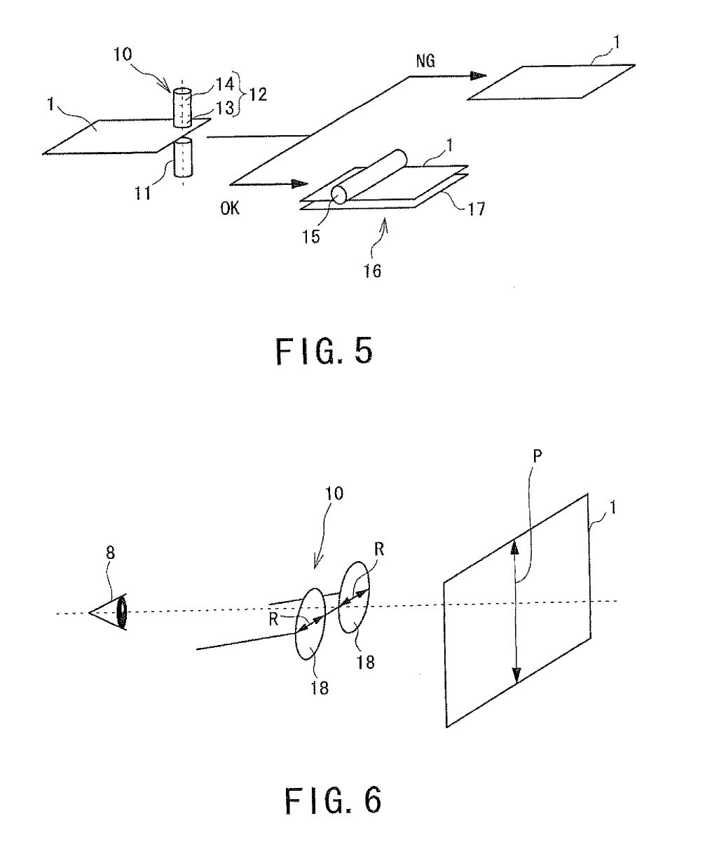

A front/back identifying device for the optical component according to the preferred embodiment of the present invention is described herein after. FIG. 5 is a view illustrating one example of the front/back identifying device for the optical component according to the preferred embodiment of the present invention. A front/back identifying device 10 for the optical component includes a light source 11 and a polarizer-equipped camera 12. The polarizer equipped camera 12 is provided with an analyzer 13 and a photodetector 14 as an observation mechanism arranged to observe light transmitting through the analyzer 13, in order from the light source 11 side. The front/back identifying device 10 can interpose the optical component 1 between the light source 11 and the polarizer-equipped camera 12.

The front/back identifying device 10 according to the preferred embodiment of the present invention is the front/back identifying device for the optical component 1 which includes the polarizing base material 2, the protective film 3 laminated on the front surface of the polarizing base material 2 and the separator 5 laminated on the back surface thereof, and includes the analyzer 13 which forms the crossed Nicols arrangement in combination with the optical component 1 as shown in FIG. 5.

For the analyzer 13 of the front/back identifying device 10, a polarizer such as a polarizing film and a polarizing prism is used. While the analyzer 13 shown in FIG. 5 has the size which covers a part of the plane of the optical component 1, the analyzer 13 may have the size which covers almost the whole plane of the optical component 1 as shown in FIG. 2 and can have the appropriate size in accordance with the type and other properties of the observation mechanism.

The light source 11 used in the front/back identifying device 10 is for emitting light to be transmitted through the crossed Nicols arrangement, an appropriate one is used in accordance with the type of the observation mechanism, and the type of the light source is not specifically limited.

It is essential only that the photodetector 14 of the polarizer-equipped camera 12 is capable of measuring the amount and/or the hue of the light transmitting through the optical component 1. For the photodetector 14, various types of photodetectors are used, for example, a tube-type photodetector such as a photomultiplier and a vidicon tube, and a semiconductor-type photodetector such as a photodiode, a MOS-type solid-state image-pickup element and a CCD-type solid-state image-pickup element.

In addition, the photodetector 14 is connected to an identifying mechanism arranged to identify the measured data on the transmitting light. The identifying mechanism stores in advance reference data on the transmitting light in a case where the protective film 3 is placed in the crossed Nicols arrangement and that in a case where the separator 5 is placed therein. Further, the identifying mechanism includes an output processing mechanism arranged to identify the front or back of the optical component 1 by comparison of observation data obtained by the photodetector 14 and the reference data, and outputs a result thereof as an electrical signal.

The front/back judging device 10 shown in FIG. 5 further includes a carrier control mechanism arranged to control the optical component 1 to be carried based on the result of the identification of the front or back of the optical component 1 by the identifying mechanism. When the identifying mechanism identifies that the front surface of the optical component 1 is placed face up, the carrier control mechanism controls the output processing mechanism to deliver an electrical signal of OK to a carrier device, and the carrier device carries the optical component 1 to a polarizing plate bonding device 16 including a pressure roller bonding device 15 based on the signal.

When the optical component 1 is carried in the direction of an arrow OK in FIG. 5 to the polarizing plate bonding device 16, the separator 5 on the back surface of the optical component 1 is peeled off so as to expose the adhesive layer 4, and the adhesive layer 4 side of the optical component 1 is bonded to a liquid crystal cell 17 below the optical component 1 by using the pressure roller bonding device 15.

Meanwhile, when the front/back identifying device 10 shown in FIG. 5 identifies that the back surface of the optical component 1 is placed face up, the carrier control mechanism controls the output processing mechanism to deliver an electrical signal of NG to the carrier device, the carrier device carries the optical component 1 based on the signal in the direction of an arrow NG in FIG. 5, which is different to the direction of the polarizing plate bonding device 16, and the optical component 1 is collected. The collected optical component 1 is set in the carrier device again so that the front surface of the optical component 1 is placed face up.

FIG. 6 is a view illustrating another example of the front/back identifying device for the optical component according to the preferred embodiment of the present invention, and the front/back identifying device 10 shown in FIG. 6 includes polarizer-equipped spectacles provided with analyzers 18 on lenses of the spectacles. In order to identify the front or back of the optical component 1 using the front/back identifying device 10, the optical component 1 is placed so that the absorption axis P of the polarizing plate 21 of the optical component 1 intersects at right angles with an absorption axis R of the analyzer 18 and light transmitting through the optical component 1 is observed with the eye 8 through the spectacles. Then, the optical component 1 is inverted, and the transmitting light is observed in a like manner. A difference between the light transmitting through the crossed Nicols arrangement in a case where the protective film is placed in the crossed Nicols arrangement and that in a case where the separator is placed therein is previously determined. The front or back of the optical component 1 is identified by comparison of the previously-determined data and a result of the observation. While the front/back identifying device 10 shown in FIG. 6 does not include a light source, environment light such as interior light can be used as a light source.

What is claimed is:

1. An optical component comprising:
a polarizing base material having a polarizing plate;
a protective film laminated on a front surface of the polarizing base material; and
a separator laminated on a back surface of the polarizing base material, wherein
when a crossed Nicols arrangement is formed between the optical component and an independently-prepared analyzer, an amount or a hue of light transmitting through the crossed Nicols arrangement in a case where placed in the crossed Nicols arrangement is the protective film differs from the amount or the hue of the light transmitting through the crossed Nicols arrangement in a case where placed in the crossed Nicols arrangement is the separator.

2. The optical component according to claim 1, wherein the protective film and the separator have different orientation angles.

3. The optical component according to claim 1, wherein the protective film and the separator have different retardation values.

4. The optical component according to claim 1, wherein the amount of the light transmitting through the crossed Nicols arrangement is arranged to be minimum when one of the protective film and the separator is placed in the crossed Nicols arrangement.

5. The optical component according to claim 1, wherein the amount of the light transmitting through the crossed Nicols arrangement is arranged to be minimum when the separator is placed in the crossed Nicols arrangement.

6. The optical component according to claim 1, wherein the protective film and the separator are uncolored and transparent.

7. The optical component according to claim 1, wherein the separator is laminated on the polarizing base material via an adhesive layer.

8. The optical component according to claim 1, wherein the polarizing base material is formed by laminating a phase difference layer on the polarizing plate by coating or the polarizing base material itself has a phase difference function.

9. An front/back identifying method of identifying the front or back of an optical component which comprises a polarizing base material having a polarizing plate, a protective film laminated on a front surface of the polarizing base material and a separator laminated on a back surface of the polarizing base material, the method comprising the steps of:
placing the optical component and an independently-prepared analyzer so as to form a crossed Nicols arrangement, the optical component being arranged so that an amount or a hue of light transmitting through the crossed Nicols arrangement in a case where placed in the crossed Nicols arrangement is the protective film differs from the amount or the hue of the light transmitting through the crossed Nicols arrangement in a case where placed in the crossed Nicols arrangement is the separator; and
observing the light transmitting through the crossed Nicols arrangement so as to identify the front or back of the optical component based on the amount or the hue of the light transmitting through the crossed Nicols arrangement.

10. The front/back identifying method for the optical component according to claim 9, wherein the light transmitting through the crossed Nicols arrangement is observed respectively in a case where one of planes of the optical component is placed in the crossed Nicols arrangement and in a case where the other plane of the optical component is placed in the crossed Nicols arrangement and the front or back of the optical component is identified based on the difference of the amount or the hue of the light transmitting through the crossed Nicols arrangement between the above cases.

11. The front/back identifying method for the optical component according to claim 9, wherein the optical component is inverted, the light transmitting through the crossed Nicols arrangement before and after inverting the optical component is observed, and the front or back of the optical component is identified based on the difference of the amount or the hue of the light transmitting through the crossed Nicols arrangement.

12. A front/back identifying device for an optical component which comprises a polarizing base material, a protective film laminated on a front surface of the polarizing base material and a separator laminated on a back surface of the polarizing base material, the device comprising:
an analyzer which forms a crossed Nicols arrangement in combination with the optical component.

13. The front/back identifying device according to claim 12, further comprising a light source for emitting light to be transmitted through the crossed Nicols arrangement.

14. The front/back identifying device according to claim 12, further comprising a transmitting light observation mechanism arranged to observe an amount or a hue of the light transmitting through the crossed Nicols arrangement.

15. The front/back identifying device according to claim 14, further comprising:
an identifying mechanism arranged to identify the front or back of the optical component based on an observation result by the transmitting light observation mechanism; and
a carrier control mechanism arranged to control the optical component to be carried based on an identification result by the identifying mechanism.

16. The front/back identifying device according to claim 12, wherein the analyzer is a polarizer-equipped camera.

17. The front/back identifying device according to claim 12, wherein the analyzer is polarizer-equipped spectacles.
